(19) United States
(12) Patent Application Publication
(10) Pub. No.: US 2026/0034391 A1
(43) Pub. Date: Feb. 5, 2026

(54) SUPPORT BRACKET SUPPORTING SUPPORT BAR, MOUNTING BRACKET FOR MOUNTING SPRINKLER REDUCER ON SUPPORT BAR, AND SPRINKLER SUPPORT ASSEMBLY INCLUDING SAME

(71) Applicant: Yoon S OH, Gyeonggi-do (KR)

(72) Inventors: Yoon S OH, Gyeonggi-do (KR); Mary Sunmin KIM, FLOWER MOUND, TX (US); Chang Ki SA, Seoul (KR)

(21) Appl. No.: 19/307,039

(22) Filed: Aug. 22, 2025

Related U.S. Application Data
(63) Continuation of application No. PCT/KR2025/010062, filed on Jul. 10, 2025.

(30) Foreign Application Priority Data
Aug. 2, 2024 (KR) 10-2024-0102907

(51) Int. Cl. A62C 35/68; F16L 3/10

(52) U.S. Cl. CPC A62C 35/68; F16L 3/1075

(57) ABSTRACT

The present disclosure relates to a mounting bracket configured to mount a sprinkler reducer to a support bar extending in a first direction. The mounting bracket includes a first base that extends in a second direction perpendicular to the first direction and passes through the support bar, and a second base that also extends in the second direction and passes through the support bar, and is rotatable relative to the first base to surround a side of the sprinkler reducer. A fixing lever is rotatable from the second base and is coupled to the first base to surround a front surface of the sprinkler reducer. The fixing lever includes fixing teeth at a portion thereof. An elastic hanger is coupled to the second base and is engaged with the fixing teeth when the first base and the second base are coupled by the fixing lever.

### CROSS-REFERENCE TO RELATED APPLICATION

This application is a US Bypass Continuation Application of International Application No. PCT/KR2025/010062, filed on Jul. 10, 2025, which claims priority to and the benefit of Korean Patent Application No. 10-2024-0102907, filed on Aug. 2, 2024, the disclosure of which is incorporated herein by reference in its entirety.

### BACKGROUND

### Technical Field

The present disclosure relates to a support bracket for supporting a support bar, a mounting bracket for mounting a sprinkler reducer on the support bar, and a sprinkler support assembly including the same.

### Background Art

A sprinkler system including a sprinkler reducer may be provided on the ceiling of a building. The sprinkler system may be mounted to the ceiling by a sprinkler support assembly.

The sprinkler reducer may be mounted on a portion of a support bar extending in one direction. A mounting bracket may be a bracket for mounting the sprinkler reducer to a portion of the support bar. Also, in order for the sprinkler reducer to be provided at a certain height, a support bracket that is disposed on a T-bar and supports the support bar is required.

To improve the working efficiency of the coupling process and decoupling process of the sprinkler reducer, the mounting bracket should be easily attachable and detachable from the sprinkler reducer and the support bar. Furthermore, the support bracket should firmly support the support bar when disposed on a T-bar during coupling process and be easily detachable from the T-bar during decoupling process.

### SUMMARY

### Technical Problem

A technical objective of present disclosure is to provide a support bracket, a mounting bracket, and a sprinkler support assembly including the same, that allow a sprinkler reducer to be easily assembled to and disassembled from a support bar.

Another technical objective of present disclosure is to provide a support bracket, a mounting bracket, and a sprinkler support assembly including the same, that enhance the structural reliability of a sprinkler reducer.

### Technical Solution

To achieve the above objectives, a mounting bracket configured to mount a sprinkler reducer on a support bar extending in a first direction may include: a first base extending in a second direction perpendicular to the first direction and passing through the support bar; a second base extending in the second direction and passing through the support bar, being rotatable relative to the first base to enclose the sprinkler reducer together with the first base; a fixing lever rotatable from the second base, coupled to the first base to enclose the front surface of the sprinkler reducer, and having fixing teeth at a portion thereof; and an elastic hanger coupled to the second base and engaged with the fixing teeth when the first base and the second base are coupled by the fixing lever.

In an exemplary embodiment, the first base may include a first base wall having a first support hole through which the support bar passes; and a plurality of first fixing walls bent from the first base wall to enclose a portion of the sprinkler reducer. The second base may include a second base wall having a second support hole through which the support bar passes; and a plurality of second fixing walls bent from the second base wall so as to at least partially overlap the plurality of first fixing walls to enclose a portion of the sprinkler reducer.

In an exemplary embodiment, the mounting bracket may further include a lever coupling shaft interposed between the plurality of first fixing walls; and a lever fixing shaft interposed between the plurality of second fixing walls. The elastic hanger is disposed between the plurality of second fixing walls to be spaced apart from the lever fixing shaft. The fixing lever may include a handle rotatable from the lever fixing shaft and having fixing teeth engaged with the elastic hanger on one side; and a locking wall rotatable from the handle and having a hook coupled with the lever coupling shaft.

In an exemplary embodiment, in a locked state where the hook is coupled with the lever coupling shaft and the fixing teeth are engaged with the elastic hanger, the first base and the second base are in contact with the sprinkler reducer, and the locking wall is spaced from the sprinkler reducer.

In an exemplary embodiment, the first base wall may include a first upper flange supporting the upper surface of the support bar, a first lower flange supporting the rear surface of the support bar, and a first side flange supporting the rear surface of the support bar. The second base wall may include a second upper flange supporting the upper surface of the support bar, a second lower flange supporting the lower surface of the support bar, and a second side flange supporting the rear surface of the support bar.

In an exemplary embodiment, the mounting bracket may further include a base rotation shaft provided at the rear of the support bar and passing through the overlapping portion of the first base and the second base.

In an exemplary embodiment, the mounting bracket may further include a spring structure surrounding the base rotation shaft. One side of the spring structure is coupled to the first base and the other side of the spring structure opposite to the one side is coupled to the second base.

In an exemplary embodiment, the first base may have a first spring coupling groove for accommodating the one side of the spring structure, and the second base may have a second spring coupling groove for accommodating the other side of the spring structure.

In an exemplary embodiment, the mounting bracket further includes a stopper protruding from the upper surface of the second base, configured to provide a restriction on the rotation of the first base.

Also, to achieve the above objectives, a support bracket disposed on a T-bar and configured to support a support bar coupled with a sprinkler reducer may include: a support frame supporting one side of the support bar, including a first support wall passing through the support bar, a second support wall facing the first support wall and passing through the support bar, and a connection wall connecting the first support wall and the second support wall; a first lower support protrusion protruding obliquely from the inner surface of the first support wall and increasing in protrusion length upward; a second lower support protrusion protruding obliquely from the inner surface of the second support wall and increasing in protrusion length upward, facing the first lower support protrusion; a first upper support protrusion provided above the first lower support protrusion, protruding obliquely from the inner surface of the first support wall and decreasing in protrusion length upward; and a second upper support protrusion provided above the second lower support protrusion, protruding from the inner surface of the second support wall and decreasing in protrusion length upward.

In an exemplary embodiment, the support bracket may further include: a first compression protrusion protruding from the inner surface of the first support wall to be positioned between the first upper support protrusion and the first lower support protrusion; and a second compression protrusion protruding from the inner surface of the second support wall to be positioned between the second upper support protrusion and the second lower support protrusion.

In an exemplary embodiment, the first support wall and the second support wall may have a distance adjustment screw hole for accommodating a distance adjustment screw that adjusts the spacing between the first support wall and the second support wall.

In an exemplary embodiment, the first support wall and the second support wall may have a fixing screw hole for accommodating a T-bar fixing screw that passes through the first support wall, the T-bar, and the second support wall to fix the T-bar to the support bracket. The fixing screw hole may be provided at an upper portion of the first lower support protrusion and the second lower support protrusion, and at a lower portion of the first upper support protrusion and the second upper support protrusion.

In an exemplary embodiment, when the support bracket is viewed in plan, the first lower support protrusion and the second lower support protrusion are arranged symmetrically.

In an exemplary embodiment, when the support bracket is viewed in plan, the first upper support protrusion and the second upper support protrusion are arranged in a zigzag pattern, not facing each other.

In an exemplary embodiment, the protrusion lengths of the first upper support protrusion and the second upper support protrusion may be greater than the protrusion lengths of the first lower support protrusion and the second lower support protrusion.

In an exemplary embodiment, the support bracket may further include a protruding support wall protruding perpendicularly from at least one of the first support wall and the second support wall, and supporting a portion of the support bar.

The first support wall and the second support wall may have a first hole for accommodating the support bar, and a second hole disposed below the first hole at a different height for accommodating the support bar.

Also, to achieve the above objectives, a sprinkler support assembly including a support bracket for supporting a support bar extending in a first direction and a mounting bracket for mounting a sprinkler reducer on the support bar may include: a T-bar including a lower portion, an extension portion extending perpendicularly from the lower portion, and a head portion protruding from the side of the extension portion; the support bracket disposed on the T-bar and supporting the support bar; and the mounting bracket mounting the sprinkler reducer on the support bar. The support bracket may include: a support frame supporting one side of the support bar, including a first support wall passing through the support bar, a second support wall facing the first support wall, and a connection wall connecting the first support wall and the second support wall; a first lower support protrusion protruding obliquely from the inner surface of the first support wall and increasing in protrusion length upward; a second lower support protrusion protruding obliquely from the inner surface of the second support wall and increasing in protrusion length upward, facing the first lower support protrusion; a first upper support protrusion provided above the first lower support protrusion, protruding obliquely from the inner surface of the first support wall and decreasing in protrusion length upward; and a second upper support protrusion provided above the second lower support protrusion, protruding from the inner surface of the second support wall and decreasing in protrusion length upward. The mounting bracket may include: a first base extending in a second direction perpendicular to the first direction, including a first base wall having a first support hole through which the support bar passes, and a plurality of first fixing walls bent from the first base wall, surrounding a portion of the support bar, and having a first fixing groove enclosing a portion of the sprinkler reducer; a second base disposed so as to at least partially overlap the first base and configured to rotate relative to the first base, including a second base wall having a second support hole through which the support bar passes, and a plurality of second fixing walls bent from the second base wall, being arranged to at least partially overlap the plurality of first fixing walls, surrounding a portion of the support bar, and having a second fixing groove enclosing a portion of the sprinkler reducer; a lever coupling shaft interposed between the plurality of first fixing walls; a lever fixing shaft interposed between the plurality of second fixing walls; an elastic hanger disposed to be spaced apart from the lever fixing shaft and interposed between the plurality of second fixing walls; and a fixing lever coupled to the lever fixing shaft and configured to couple and decouple the first base and the second base, including a handle rotatable from the lever fixing shaft and having fixing teeth engaged with the elastic hanger on one side, and a locking member rotatable from the handle and having a hook coupled with the lever coupling shaft.

### Effect of the Invention

The mounting bracket of the present disclosure may include a first base, a second base rotatable from the first base, and a fixing lever coupling the first base and the second base, thereby enabling the sprinkler reducer to be easily assembled to and disassembled from the support bar.

Further, due to the structure of the mounting bracket, physical damage to the sprinkler reducer can be prevented.

The support bracket of the present disclosure may include first and second lower support protrusions, first and second upper support protrusions, and first and second compression protrusions, thereby enabling the support bracket to be securely fixed to the T-bar (Tb).

The sprinkler support assembly of the present disclosure may include the above-described mounting bracket and support bracket, thereby enabling easy mounting of the sprinkler reducer to the support bar and improving the structural reliability of the sprinkler reducer.

### BRIEF DESCRIPTION OF THE DRAWINGS

FIG. 1 is a perspective view of a sprinkler support assembly according to an exemplary embodiment of the present disclosure.

FIG. 2 is a front perspective view of a mounting bracket according to an exemplary embodiment of the present disclosure.

FIGS. 3A and 3B are rear perspective views of the mounting bracket according to an exemplary embodiment of the present disclosure.

FIGS. 4A to 4D are views illustrating a coupling process of the mounting bracket and a sprinkler reducer according to an exemplary embodiment of the present disclosure.

FIG. 5 is a side view of the mounting bracket in a locked state according to an exemplary embodiment of the present disclosure.

FIG. 6 is a perspective view of another exemplary embodiment of a mounting bracket according to an exemplary embodiment of the present disclosure.

FIG. 7 is a perspective view of a support bracket in a coupled state with a T-bar and a support bar according to an exemplary embodiment of the present disclosure.

FIG. 8 is a perspective view of the support bracket in a decoupled state from the T-bar and the support bar according to an exemplary embodiment of the present disclosure.

FIG. 9 is a side view of the support bracket according to an exemplary embodiment of the present disclosure.

FIG. 10 is a bottom view of the support bracket according to an exemplary embodiment of the present disclosure.

FIG. 11 is an enlarged view of a part of the support bracket coupled with the T-bar according to an exemplary embodiment of the present disclosure.

### DETAILED DESCRIPTION

Hereinafter, preferred embodiments of the present disclosure will be described in detail with reference to the accompanying drawings. The advantages and features of the present disclosure, and methods for achieving them, will become more apparent from the following detailed description of embodiments in conjunction with the accompanying drawings. However, the technical scope of the present disclosure is not limited to these embodiments and may be implemented in various other forms. These embodiments are provided to fully disclose the technical spirit of the present disclosure and to enable those skilled in the art to understand the scope of the invention. The technical scope of the present disclosure is defined only by the claims.

In the drawings, reference numerals are assigned to elements, and the same reference numerals are used for elements that are the same or substantially the same, even if they appear in different drawings. In describing the present disclosure, detailed explanations of known functions or configurations may be omitted when it is determined that such detail may unnecessarily obscure the subject matter of the disclosure.

Unless otherwise defined, all terms used herein (including technical and scientific terms) have the same meaning as commonly understood by those of ordinary skill in the art to which the present disclosure pertains. Terms defined in general dictionaries are to be interpreted as having meanings consistent with their context in the relevant art and are not to be interpreted in an idealized or overly formal sense unless explicitly defined otherwise herein. The terminology used herein is for the purpose of describing particular embodiments and is not intended to limit the scope of the present disclosure. The singular forms used herein include plural forms as well, unless the context clearly indicates otherwise.

In describing the components of the present disclosure, terms such as first, second, A, B, (a), (b), etc., may be used. These terms are merely for distinguishing one component from another and do not imply any limitation on the nature, order, or sequence of the components. When a component is described as being “connected,” “coupled,” or “joined” to another component, it may be directly connected or coupled to the other component, or there may be an intervening component between them unless otherwise stated.

The terms “comprises” and/or “comprising” as used herein do not exclude the presence of other elements, steps, operations, or components not listed.

Components included in one embodiment and having the same or similar functions may be described using the same names in other embodiments. Unless otherwise specified, the descriptions of any one embodiment may be applicable to other embodiments, and redundant or readily understood descriptions may be omitted.

Hereinafter, preferred embodiments of the present disclosure will be described in detail with reference to the accompanying drawings.

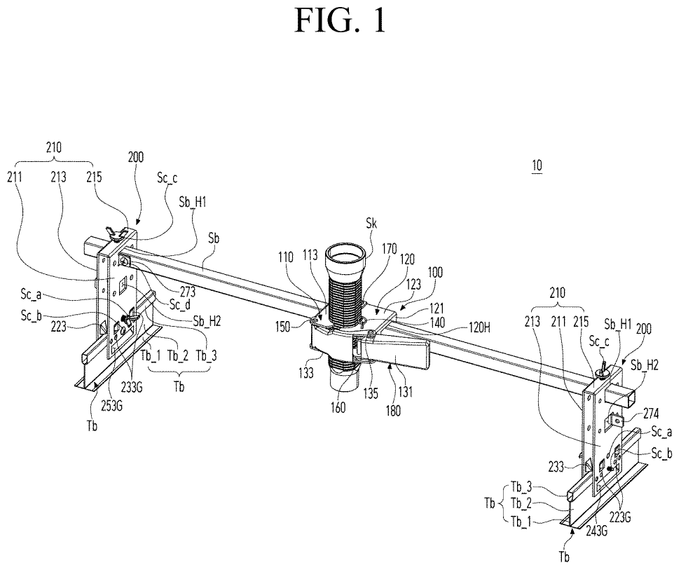

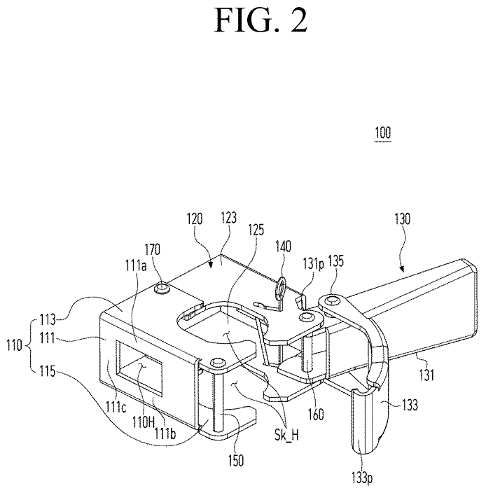

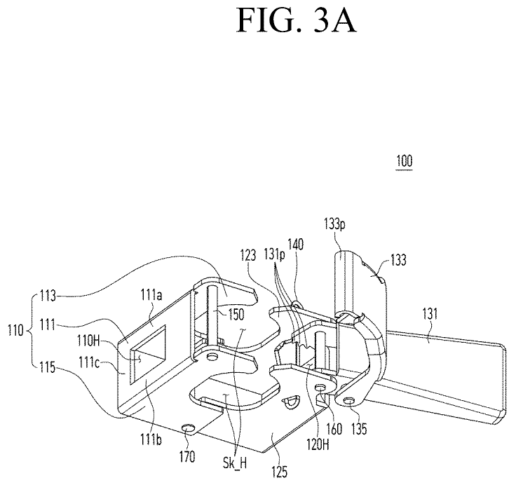

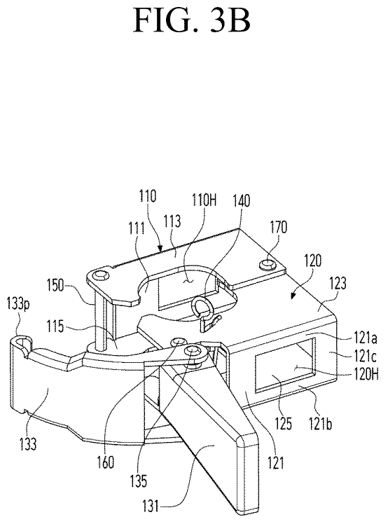

FIG. 1 is a perspective view of a sprinkler support assembly 10 according to an exemplary embodiment of the present disclosure. FIG. 2 is a front perspective view of a mounting bracket 100 according to an exemplary embodiment of the present disclosure, and FIGS. 3A and 3B are rear perspective views of the mounting bracket 100 according to an exemplary embodiment of the present disclosure.

Referring to FIGS. 1 to 3B, the sprinkler support assembly 10 may include a T-bar Tb, a support bar Sb, the mounting bracket 100 configured to mount a sprinkler reducer Sk onto the support bar Sb, and a support bracket 200 configured to support the support bar Sb on the T-bar Tb.

The T-bar Tb may have a cross-sectional shape in the form of the letter T and may support the support bracket (200). For example, a portion of the outer surface of the T-bar Tb may be compressed by the support bracket 200.

The T-bar Tb may include a base portion Tb_1, an extension portion Tb_2 extending perpendicularly from the base portion Tb_1, and a head portion Tb_3 protruding from the side of the extension portion Tb_2.

The support bar Sb may be a bar extending in a first direction (e.g., parallel to the floor) to support the sprinkler reducer Sk. For example, the cross-section of the support bar Sb may be rectangular, but is not limited thereto.

The mounting bracket 100 may be configured to mount the sprinkler reducer Sk onto the support bar Sb extending in the first direction. The mounting bracket 100 may include a first base 110, a second base 120, a fixing lever 130, an elastic hanger 140, a lever coupling shaft 150, a lever fixing shaft 160, and a base rotation shaft 170.

The first base 110 may extend in a second direction perpendicular to the first direction. The second direction may be parallel to the floor and perpendicular to the first direction. The first base 110 may pass through the support bar Sb via a first support hole 110H.

The second base 120 may also extend in the second direction. In addition, the second base 120 may pass through the support bar Sb via a second support hole 120H. The second base 120 may be rotatably coupled to a portion of the first base 110. In other words, the second base 120 may be configured to rotate relative to the first base 110. The first base 110 and the second base 120 may enclose at least a portion of the sprinkler reducer Sk.

The first base 110 may include a first base wall 111 having the first support hole 110H and a plurality of first fixing walls 113, 115 bent from the first base wall 111 to enclose a portion of the sprinkler reducer Sk.

In an exemplary embodiment, the plurality of first fixing walls may include a first upper fixing wall 113 bent from the upper portion of the first base wall 111 and a first lower fixing wall 115 bent from the lower portion of the first base wall 111. For example, the first upper fixing wall 113 and the first lower fixing wall 115 may face each other in in parallel.

Similarly, the second base 120 may include a second base wall 121 having the second support hole 120H, and a plurality of second fixing walls 123, 125 bent from the second base wall 121 so as to at least partially overlap the plurality of first fixing walls 113, 115 to enclose a portion of the sprinkler reducer Sk.

In an exemplary embodiment, the plurality of second fixing walls 123, 125 may include a second upper fixing wall 123 bent from the upper portion of the second base wall 121 and overlapping a portion of the first upper fixing wall 113, and a second lower fixing wall 125 bent from the lower portion of the second base wall 121 and overlapping a portion of the first lower fixing wall 115. For example, the first lower fixing wall 115 and the second lower fixing wall 125 may face each other in parallel.

In an exemplary embodiment, the first base 110 may enclose at least a portion of the second base 120. Specifically, the first upper fixing wall 113 of the first base 110 may enclose a portion of the second upper fixing wall 123 of the second base 120. In addition, the first lower fixing wall 115 of the first base 110 may enclose a portion of the second lower fixing wall 125 of the second base 120. Accordingly, the first base 110 and the second base 120 may be rotatably coupled in a stable manner.

In an exemplary embodiment, a first spacing distance between the first upper fixing wall 113 and the first lower fixing wall 115 of the first base 110 may be greater than a second spacing distance between the second upper fixing wall 123 and the second lower fixing wall 125 of the second base 120.

The base rotation shaft 170 may be provided at the rear of the support bar Sb and may pass through the overlapping portion of the first base 110 and the second base 120 to couple the first base 110 and the second base 120. Accordingly, the second base 120 may be rotatable relative to the first base 110 via the base rotation shaft 170. That is, the first base 110 and the second base 120 may rotate about the base rotation shaft 170 to contact or be spaced apart from the side of the sprinkler reducer Sk.

The lever coupling shaft 150 may be a coupling shaft provided in the first base 110 to couple the fixing lever 130 to the first base 110. In an exemplary embodiment, the lever coupling shaft 150 may be interposed between the plurality of first fixing walls 113, 115 of the first base 110.

The lever fixing shaft 160 may be a fixing shaft provided in the second base 120 to fix the fixing lever 130 to the second base 120. In an exemplary embodiment, the lever fixing shaft 160 may be interposed between the plurality of second fixing walls 123 and 125 of the second base 120.

The elastic hanger 140 may be provided inside the second base 120 and may be configured to engage with the fixing teeth 131p of the fixing lever 130 when the first base 110 and the second base 120 are coupled.

In an exemplary embodiment, the elastic hanger 140 may be interposed between the second upper fixing wall 123 and the second lower fixing wall 125 of the second base 120 and may serve as an elastic engagement member that engages with the fixing teeth 131p. For example, the elastic hanger 140 may be a bar provided in the form of a clip. However, the shape of the elastic hanger 140 is not limited to this example.

The fixing lever 130 may be rotatable from a portion of the second base 120 to couple and decouple the first base 110. In an exemplary embodiment, the fixing lever 130 may rotate in a first rotational direction from a portion of the second base 120 to be coupled to the lever coupling shaft 150. In this case, the fixing lever 130 may enclose a front surface of the sprinkler reducer Sk.

In another exemplary embodiment, the fixing lever 130 may rotate in a second rotational direction opposite to the first rotational direction from a portion of the second base 120 to be decoupled from the lever coupling shaft 150. In this case, the fixing lever 130 may not enclose the front surface of the sprinkler reducer Sk.

The fixing lever 130 may include a handle 131 configured to rotate from the lever fixing shaft 160 and having the fixing teeth 131p that engage with the elastic hanger 140 on one side. The fixing lever 130 may further include a locking wall 133 configured to rotate from the handle 131 and having a hook 133p that couples with the lever coupling shaft 150. For example, a locking rotation shaft 135 rotatably couples the locking wall 133 and the handle 131, and the locking wall 133 may be configured to rotate from the handle 131 about the locking rotation shaft 135.

In an exemplary embodiment, when the hook 133p of the locking wall 133 is coupled with the lever coupling shaft 150 and the handle 131 rotates in a direction toward the support bar Sb, the fixing teeth 131p provided on the inner side of the handle 131 may engage with the elastic hanger 140. As the fixing teeth 131p engage with the elastic hanger 140, rotation of the handle 131 about the locking rotation shaft 135 may be restricted. A state in which the hook 133p of the locking wall 133 is coupled with the lever coupling shaft 150 and the fixing teeth 131p are engaged with the elastic hanger 140 may be defined as a locked state of the mounting bracket 100.

In an exemplary embodiment, when the handle 131 rotates in a direction away from the support bar Sb in a locked state of the mounting bracket 100, the elastic hanger 140 may be pushed by the fixing teeth 131p, thereby releasing the engagement between the elastic hanger 140 and the fixing teeth 131p. As the engagement between the fixing teeth 131p and the elastic hanger 140 is released, rotation of the handle 131 about the locking rotation shaft 135 may become free. Accordingly, the coupling between the hook 133p of the locking wall 133 and the lever coupling shaft 150 may also be easily released. A state in which the coupling between the hook 133p of the locking wall 133 and the lever coupling shaft 150 is released and the engagement between the fixing teeth 131p and the elastic hanger 140 is released may be defined as an open state of the mounting bracket 100.

In an exemplary embodiment, in the locked state of the mounting bracket 100, the side of the sprinkler reducer Sk may be pressed by the first base 110 and the second base 120. In addition, in the locked state of the mounting bracket 100, the rear of the sprinkler reducer Sk may be pressed by a front surface of the support bar Sb.

In an exemplary embodiment, in the locked state of the mounting bracket 100, a front surface of the sprinkler reducer Sk may be enclosed by the locking wall 133. In this case, the locking wall 133 may be spaced apart from the front surface of the sprinkler reducer Sk without contacting the front surface thereof.

In the locked state of the mounting bracket 100, the first base 110 and the second base 120 may be in close contact with the side of the sprinkler reducer Sk, and the support bar Sb may be in close contact with the rear of the sprinkler reducer Sk. Accordingly, the mounting bracket 100 may be firmly mounted to the support bar Sb.

In addition, since the locking wall 133 may be spaced apart from the surface portion of the sprinkler reducer Sk, a space may be secured in front of the sprinkler reducer Sk, and the sprinkler reducer Sk may not directly receive a pressing force from the fixing lever 130. Accordingly, physical damage to the sprinkler reducer Sk and the fixing lever 130 may be reduced.

In the open state of the mounting bracket 100, the first base 110 and the second base 120 may release close contact with the side portion of the sprinkler reducer Sk. Accordingly, the size of a hole Sk_H surrounding the sprinkler reducer Sk may increase, enabling the sprinkler reducer Sk to be easily decoupled from the mounting bracket 100.

In an exemplary embodiment, the first base wall 111 may include a first upper flange 111a supporting an upper surface of the support bar Sb, a first lower flange 111b supporting a lower surface of the support bar Sb, and a first side flange 111c supporting a rear surface of the support bar Sb.

Specifically, the first upper flange 111a may be a flange provided at an upper portion of the first base wall 111 and may support an upper surface of the support bar Sb. The first lower flange 111b may be a flange provided at a lower portion of the first base wall 111 and may support a lower surface of the support bar Sb. The first side flange 111c may be a flange provided at a side portion of the first base wall 111 and may support a side surface of the support bar Sb. Since the first base wall 111 may include the above-described flanges, the first base wall 111 may firmly support the support bar Sb.

In addition, the second base wall 121 may include a second upper flange 121a supporting an upper surface of the support bar Sb, a second lower flange 121b supporting a lower surface of the support bar Sb, and a second side flange 121c supporting a rear surface of the support bar Sb.

Specifically, the second upper flange 121a may be a flange provided at an upper portion of the second base wall 121 and may support an upper surface of the support bar Sb. The second lower flange 121b may be a flange provided at a lower portion of the second base wall 121 and may support a lower surface of the support bar Sb. The second side flange 121c may be a flange provided at a side portion of the second base wall 121 and may support a side surface of the support bar Sb. Since the second base wall 121 may include the above-described flanges, the second base wall 121 may firmly support the support bar Sb.

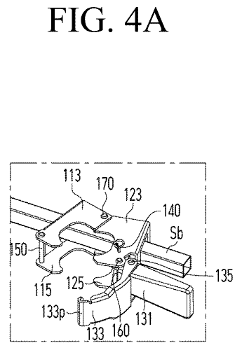

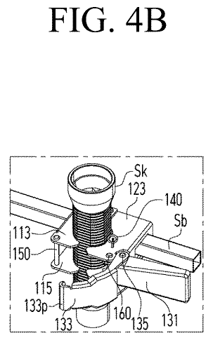

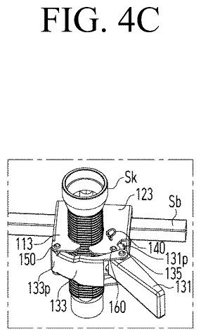

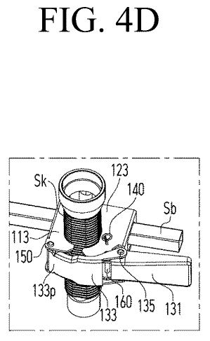

FIGS. 4A to 4D are views illustrating a coupling process of the mounting bracket and a sprinkler reducer according to an exemplary embodiment of the present disclosure.

Referring to FIG. 4A, the first base 110 may pass through the support bar Sb via the first support hole 110H, and the second base 120 may pass through the support bar Sb via the second support hole 120H. In addition, to facilitate the insertion and removal of the sprinkler reducer Sk, the first base 110 and the second base 120 may rotate about the base rotation shaft 170 to increase the size of a hole Sk_H that encloses the sprinkler reducer Sk.

Referring to FIG. 4B, when the sprinkler reducer Sk is positioned in a space between the first base 110 and the second base 120, the first base 110 and the second base 120 may rotate about the base rotation shaft 170 to surround at least a portion of a side portion and a front surface of the sprinkler reducer Sk.

Referring to FIG. 4C, after the first base 110 and the second base 120 surround the side portion of the sprinkler reducer Sk, the hook 133p of the locking wall 133 may rotate from the locking rotation shaft 135 and be coupled to the lever coupling shaft 150. In this state, the fixing teeth 131p provided on an inner portion of the handle 131 may not be engaged with the elastic hanger 140.

Referring to FIG. 4D, after the hook 133p of the locking wall 133 is coupled to the lever coupling shaft 150, the handle 131 may be rotated by the user in a direction toward the support bar Sb. In this state, the fixing teeth 131p provided on an inner portion of the handle 131 may be engaged with the elastic hanger 140. As the fixing teeth 131p engage with the elastic hanger 140, rotation of the handle 131 about the locking rotation shaft 135 may be restricted. A state in which the hook 133p of the locking wall 133 is coupled to the lever coupling shaft 150 and the fixing teeth 131p are engaged with the elastic hanger 140 may be defined as a locked state of the mounting bracket 100.

In the locked state of the mounting bracket 100, the first base 110 and the second base 120 may be in close contact with at least a portion of a side portion and a front surface of the sprinkler reducer Sk, and the support bar Sb may be in close contact with a rear portion of the sprinkler reducer Sk. Accordingly, the mounting bracket 100 may be firmly mounted to the support bar Sb.

In the locked state of the mounting bracket 100, the locking wall 133 may be spaced apart from the front surface of the sprinkler reducer Sk without contacting it, so that a space may be secured in a front portion of the sprinkler reducer Sk. Accordingly, the sprinkler reducer Sk may not directly receive a force applied by the fixing lever 130. That is, physical damage caused by contact between the sprinkler reducer Sk and the fixing lever 130 may be prevented.

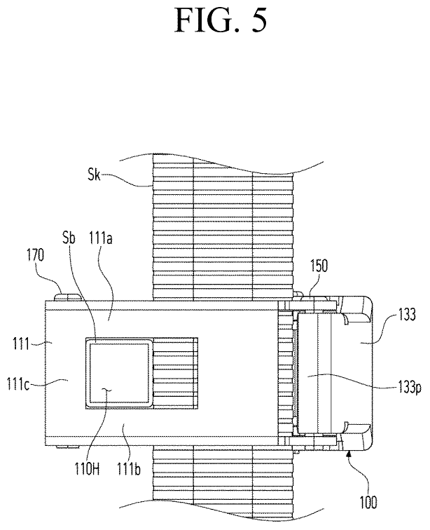

FIG. 5 is a side view of the mounting bracket in a locked state according to an exemplary embodiment of the present disclosure.

Referring to FIG. 5, the first base wall 111 may include a first upper flange 111a supporting an upper surface of the support bar Sb, a first lower flange 111b supporting a lower surface of the support bar Sb, and a first side flange 111c supporting a rear surface of the support bar Sb.

In addition, the second base wall 121 may include a second upper flange 121a supporting an upper surface of the support bar Sb, a second lower flange 121b supporting a lower surface of the support bar Sb, and a second side flange 121c supporting a rear surface of the support bar Sb.

Since the first base wall 111 and the second base wall 121 may include the above-described flanges, the first base wall 111 and the second base wall 121 may firmly support the support bar Sb. In addition, by including the above-described flanges, the height (i.e., the length in the vertical direction) of the first base wall 111 and the second base wall 121 may be relatively increased. Accordingly, the durability of the first base 110 and the second base 120 may be improved.

In the locked state of the bracket 100, the first base 110 and the second base 120 may be in close contact with at least a portion of a side portion and a front surface of the sprinkler reducer Sk, and the support bar Sb may be in close contact with a rear portion of the sprinkler reducer Sk. Accordingly, the mounting bracket 100 may be firmly mounted to the support bar Sb.

In addition, the locking wall 133 may be spaced apart from the front surface of the sprinkler reducer Sk, so that a space may be secured in a front portion of the sprinkler reducer Sk, and the sprinkler reducer Sk may not directly receive a pressing force from the fixing lever 130.

In an exemplary embodiment, the sprinkler reducer Sk may not receive force from all four directions (e.g., a front direction, a rear direction, a left direction, and a right direction), and may receive force only from three directions (e.g., a rear direction, a left direction, and a right direction). In such a situation, a space may be secured in a front portion of the sprinkler reducer Sk, thereby reducing physical damage to the sprinkler reducer Sk. In addition, since the sprinkler reducer Sk and the fixing lever 130 do not directly contact each other, physical damage to the fixing lever 130 may also be reduced.

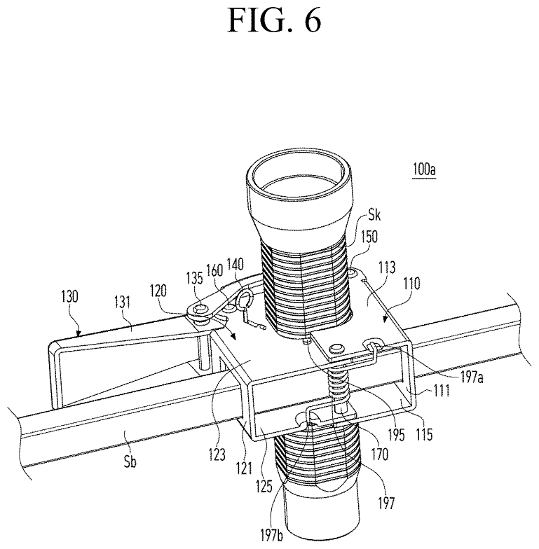

FIG. 6 is a perspective view of another exemplary embodiment of a mounting bracket according to an exemplary embodiment of the present disclosure.

In the following, overlapping contents between the mounting bracket 100a of FIG. 6 and the mounting bracket 100 described with reference to FIGS. 1 to 5 will be omitted, and differences will be mainly described.

Referring to FIG. 6, the mounting bracket 100a of the present disclosure may include a stopper 195. The stopper 195 of the present disclosure may be provided on the second upper fixing wall 123 of the second base 120.

In an exemplary embodiment, the stopper 195 may be provided in the form of a protrusion protruding from an upper surface of the second upper fixing wall 123. The stopper 195 may provide a restriction on the rotation of the first base 110. Specifically, when the first base 110 rotates in a direction to increase the size of a hole that surrounds the sprinkler reducer Sk (i.e., in a direction away from the second base 120), the stopper 195 may not provide a restriction on the rotation of the first base 110.

Conversely, when the first base 110 rotates in a direction to decrease the size of the hole that surrounds the sprinkler reducer Sk (i.e., in a direction toward the second base 120), the stopper 195 may provide a restriction on the rotation of the first base 110.

In an exemplary embodiment, the stopper 195 may be provided in a cylindrical shape, but the shape is not limited thereto. In addition, the level of an upper surface of the stopper 195 may be lower than the level of the first upper fixing wall 113 of the first base 110. However, the present disclosure is not limited thereto, and the level of the upper surface of the stopper 195 may be substantially the same as the level of the first upper fixing wall 113 of the first base 110.

Since the mounting bracket 100a of the present disclosure may include the stopper 195, the size of the hole Sk_H that surrounds the sprinkler reducer Sk may be secured to a specific size or greater. Accordingly, coupling of the sprinkler reducer Sk using the mounting bracket 100a of the present disclosure may be facilitated.

In addition, the mounting bracket 100a of the present disclosure may include a spring structure 197 that encloses the base rotation shaft 170. In an exemplary embodiment, a central portion of the spring structure 197 may be provided in a coil shape and may enclose the base rotation shaft 170.

In addition, one side 197a of the spring structure 197 may be coupled to the first upper fixing wall 113 of the first base 110, and the other side 197b opposite to the one side 197a may be coupled to the second lower fixing wall 125 of the second base 120.

When installing the sprinkler reducer Sk, it may be important to finely adjust the mounting height of the sprinkler reducer Sk. However, when the hook 133p of the locking wall 133 is coupled to the lever coupling shaft 150, the sprinkler reducer Sk and the mounting bracket 100a may be firmly coupled, making it difficult to finely adjust the mounting height of the sprinkler reducer Sk.

Since the mounting bracket 100a of the present disclosure may include the spring structure 197, even when the hook 133p of the locking wall 133 of the present disclosure is not coupled to the locking rotation shaft 135, the mounting bracket 100a may be secondarily brought into close contact with a side portion of the sprinkler reducer Sk by the elasticity of the spring structure 197.

In this case, the worker may use a hand force greater than the elastic force provided by the spring structure 197 to easily control the size of the hole Sk_H that surrounds the sprinkler reducer Sk. Accordingly, the mounting height of the sprinkler reducer Sk may be finely adjusted.

In an exemplary embodiment, the one side 197a of the spring structure 197 may extend from a central portion that encloses the base rotation shaft 170 and may be coupled to the first upper fixing wall 113. The first upper fixing wall 113 may have a first spring coupling groove for accommodating the one side 197a of the spring structure 197.

In an exemplary embodiment, the other side 197b of the spring structure 197 may extend from a central portion that encloses the base rotation shaft 170 and may be coupled to the second lower fixing wall 125. The second lower fixing wall 125 may have a second spring coupling groove for accommodating the other side 197b of the spring structure 197.

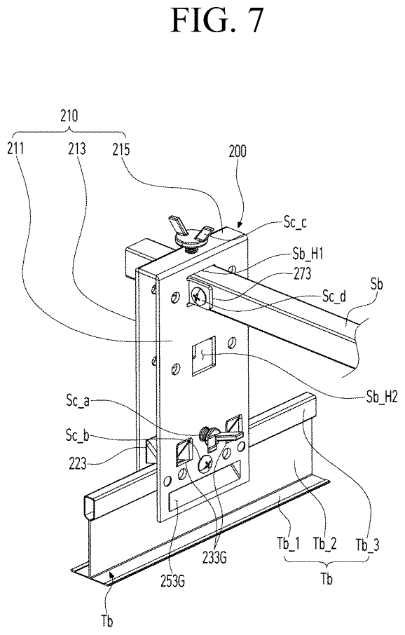

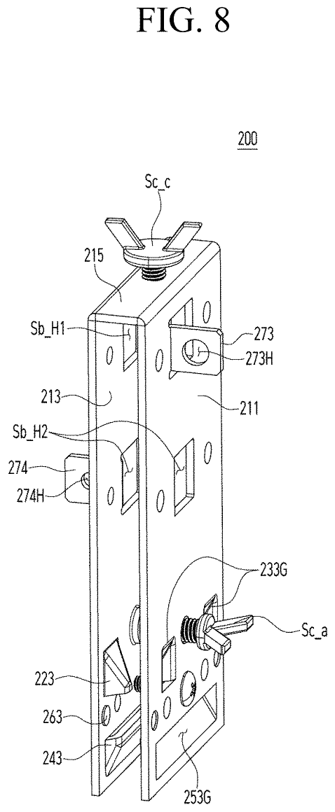

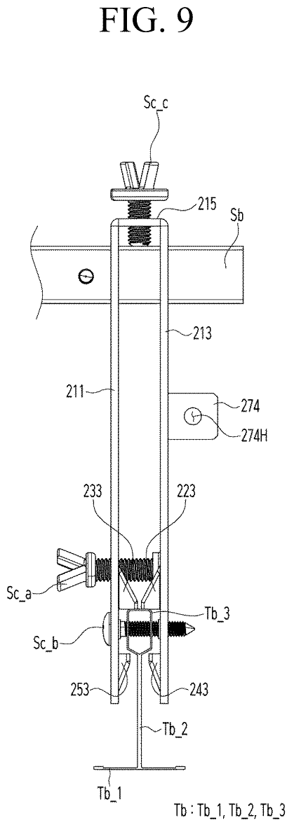

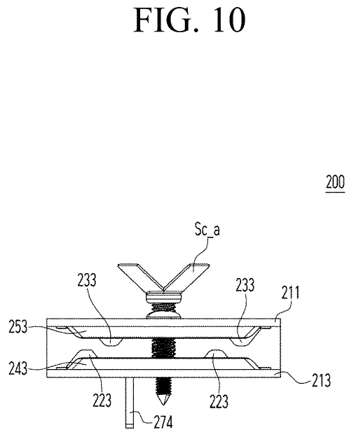

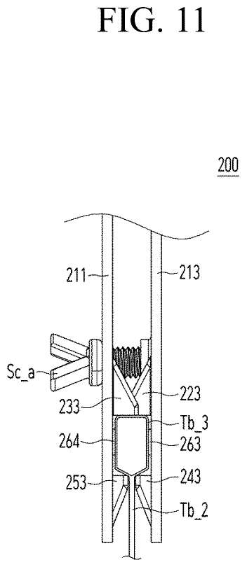

FIG. 7 is a perspective view of a support bracket in a coupled state with a T-bar and a support bar according to an exemplary embodiment of the present disclosure. FIG. 8 is a perspective view of the support bracket in a decoupled state from the T-bar and the support bar according to an exemplary embodiment of the present disclosure. FIG. 9 is a side view of the support bracket according to an exemplary embodiment of the present disclosure. FIG. 10 is a bottom view of the support bracket according to an exemplary embodiment of the present disclosure. FIG. 11 is an enlarged view of a part of the support bracket coupled with the T-bar according to an exemplary embodiment of the present disclosure.

Referring to FIG. 1 and FIGS. 7 to 11 together, the support bracket 200 of the present disclosure may be a bracket disposed on a T-bar Tb and supporting an edge portion of a support bar Sb that is coupled with a sprinkler reducer Sk.

The support bracket 200 may include a support frame 210 supporting one side of the support bar Sb, a plurality of lower support protrusions 243, 253 protruding from inside of the support frame 210 and supporting the extension portion Tb_2 of the T-bar Tb, a plurality of upper support protrusions 223, 233 protruding from inside of the support frame 210 and supporting an upper surface of the head portion Tb_3 of the T-bar Tb, and a plurality of compression protrusions 263, 264 protruding from inside of the support frame 210 and supporting a side surface of the head portion Tb_3 of the T-bar Tb.

The support frame 210 of the present disclosure may include a first support wall 211 passing through the support bar Sb, a second support wall 213 facing the first support wall 211 and passing through the support bar Sb, and a connection wall 215 bent from the first support wall 211 and the second support wall 213 to connect the first support wall 211 and the second support wall 213.

In an exemplary embodiment, the first support wall 211 may be one wall of the support frame 210 and may be a wall relatively closer to the sprinkler reducer Sk, and the second support wall 213 may be another wall of the support frame 210 and may be a wall relatively farther from the sprinkler reducer Sk.

In addition, the first support wall 211 and the second support wall 213 may face each other in parallel, and the first support wall 211 and the second support wall 213 may extend in a direction in which the sprinkler reducer Sk extends.

The first lower support protrusion 253 may protrude obliquely from an inner surface of the first support wall 211 and may increase in protrusion length upward. In addition, the first lower support protrusion 253 may press the extension portion Tb_2 provided below the head portion Tb_3 of the T-bar Tb.

In an exemplary embodiment, the protrusion length of the first lower support protrusion 253 may increase upward, so that the first lower support protrusion 253 may guide the insertion of the T-bar Tb easily and prevent the T-bar Tb from being released after insertion.

In an exemplary embodiment, the first lower support protrusion 253 may be provided as a single member. In addition, the first lower support protrusion 253 may extend in a direction parallel to a direction in which the T-bar Tb extends. When viewed from a side, the first lower support protrusion 253 may be provided in a trapezoidal shape having an inclined slope. The first lower support protrusion 253 may also be provided in a triangular shape.

The second lower support protrusion 243 may be a protrusion protruding obliquely from an inner surface of the second support wall 213 and increasing in protrusion length upward. In addition, the second lower support protrusion 243 may press the extension portion Tb_2, provided below the head portion Tb_3 of the T-bar Tb, together with the first lower support protrusion 253.

In an exemplary embodiment, the protrusion length of the second lower support protrusion 243 may increase upward, so that the second lower support protrusion 243 may guide the insertion of the T-bar Tb easily and prevent the T-bar Tb from being released after insertion.

In an exemplary embodiment, the second lower support protrusion 243 may be provided as a single member. In addition, the second lower support protrusion 243 may extend in a direction parallel to a direction in which the T-bar Tb extends. When viewed from a side, the second lower support protrusion 243 may be provided in a trapezoidal shape having an inclined slope. The second lower support protrusion 243 may also be provided in a triangular shape.

In an exemplary embodiment, when the support bracket 200 is viewed in plan, the first lower support protrusion 253 and the second lower support protrusion 243 may be arranged symmetrically. Since the first lower support protrusion 253 and the second lower support protrusion 243 may be arranged symmetrically, they may apply symmetrical pressure to the extension portion Tb_2 of the T-bar Tb.

The first upper support protrusion 233 may be a protrusion protruding obliquely from an inner surface of the first support wall 211 and decreasing in protrusion length upward. In addition, the first upper support protrusion 233 may be in close contact with an upper surface of the head portion Tb_3 of the T-bar Tb. That is, the first upper support protrusion 233 may serve as a stopper that restricts movement of the T-bar Tb.

In an exemplary embodiment, as the first upper support protrusion 233 extends downward, its cross-sectional area in the horizontal direction may increase, thereby increasing the contact area between the upper surface of the head portion Tb_3 of the T-bar Tb and the first upper support protrusion 233.

In an exemplary embodiment, the first upper support protrusion 233 may be provided in plurality. For example, the first upper support protrusion 233 may be provided as two members. In addition, the first upper support protrusion 233 may be provided in a trapezoidal shape having an inclined slope.

The second upper support protrusion 223 may be a protrusion protruding obliquely from an inner surface of the second support wall 213 and decreasing in protrusion length upward. In addition, the second upper support protrusion 223 may be in close contact with an upper surface of the head portion Tb_3 of the T-bar Tb. That is, the second upper support protrusion 223 may serve as a stopper that restricts movement of the T-bar Tb.

In an exemplary embodiment, as the second upper support protrusion 223 extends downward, its cross-sectional area in the horizontal direction may increase, thereby increasing the contact area between the upper surface of the head portion Tb_3 of the T-bar Tb and the second upper support protrusion 223.

In an exemplary embodiment, the second upper support protrusion 223 may be provided in plurality. For example, the second upper support protrusion 223 may be provided as two members. In addition, the second upper support protrusion 223 may be provided in a trapezoidal shape having an inclined slope.

In an exemplary embodiment, when the support bracket 200 is viewed in plan, the first upper support protrusion 233 and the second upper support protrusion 223 may be arranged in a zigzag pattern. That is, when the support bracket 200 is viewed in plan, the first upper support protrusion 233 and the second upper support protrusion 223 may not overlap each other.

In an exemplary embodiment, since the first upper support protrusion 233 and the second upper support protrusion 223 may be arranged in a zigzag pattern, the first upper support protrusion 233 and the second upper support protrusion 223 may contact an upper surface of the head portion Tb_3 of the T-bar Tb with a relatively large area.

In addition, since the first upper support protrusion 233 and the second upper support protrusion 223 may not overlap each other in space above the T-bar Tb, adjustment of a distance between the first support wall 211 and the second support wall 213 of the support bracket 200 by the distance adjustment screw Sc_a may be facilitated.

In addition, since the first upper support protrusion 233 and the second upper support protrusion 223 may not overlap each other in space above the T-bar Tb, the protrusion lengths of the first upper support protrusion 233 and the second upper support protrusion 223 may be provided to be greater than those of the first lower support protrusion 253 and the second lower support protrusion 243.

In an exemplary embodiment, the first support wall 211 and the second support wall 213 may have a first hole Sb_H1 for accommodating the support bar Sb. In addition, the first support wall 211 and the second support wall 213 may have a second hole Sb_H2, provided below the first hole Sb_H1, for accommodating the support bar Sb.

Since the first support wall 211 and the second support wall 213 may have the first hole Sb_H1 and the second hole Sb_H2, the support bracket 200 of the present disclosure may selectively support the support bar Sb at different heights.

In an exemplary embodiment, a portion of the outer surface of the first support wall 211 overlapping the first upper support protrusion 233 may have a first upper support groove 233G. In addition, a portion of the outer surface of the first support wall 211 overlapping the first lower support protrusion 253 may have a first lower support groove 253G.

A portion of the outer surface of the second support wall 213 overlapping the second upper support protrusion 223 may have a second upper support groove 223G. In addition, a portion of the outer surface of the second support wall 213 overlapping the second lower support protrusion 243 may have a second lower support groove 243G.

Since the support bracket 200 of the present disclosure may have the first upper support groove 233G, the second upper support groove 223G, the first lower support groove 253G, and the second lower support groove 243G described above, the weight of the support bracket 200 may be reduced, and the gripping ease of the support bracket 200 by a user may be improved.

In an exemplary embodiment, the first compression protrusion 264 may protrude from an inner surface of the first support wall 211 and may press a side surface of the head portion Tb_3 of the T-bar Tb. In addition, the first compression protrusion 264 may be provided as two members at edges of the first support wall 211. However, the number and position of the first compression protrusion 264 are not limited to the above.

In addition, the first compression protrusion 264 may be disposed between the first upper support protrusion 233 and the first lower support protrusion 253. In an exemplary embodiment, the first compression protrusion 264 may be provided to have a uniform cross-sectional area in a vertical direction.

In an exemplary embodiment, the second compression protrusion 263 may protrude from an inner surface of the second support wall 213 and may press a side surface of the head portion Tb_3 of the T-bar Tb. In addition, the second compression protrusion 263 may be provided as two members at edges of the second support wall 213. However, the number and position of the second compression protrusion 263 are not limited to the above.

The second compression protrusion 263 may be disposed between the second upper support protrusion 223 and the second lower support protrusion 243. In an exemplary embodiment, the second compression protrusion 263 may be provided to have a uniform cross-sectional area in a vertical direction.

In an exemplary embodiment, when the support bracket 200 is viewed in plan, the first compression protrusion 264 and the second compression protrusion 263 may be arranged symmetrically. Since the first compression protrusion 264 and the second compression protrusion 263 may be arranged symmetrically, they may apply symmetrical pressure to the side surface of the head portion Tb_3 of the T-bar Tb.

Since the support bracket 200 of the present disclosure may include the first lower support protrusion 253 and the second lower support protrusion 243, the first upper support protrusion 233 and the second upper support protrusion 223, and the first compression protrusion 264 and the second compression protrusion 263, an upper portion, a lower portion, and a side portion of the head portion Tb_3 of the T-bar Tb may be firmly supported by the support bracket 200.

In an exemplary embodiment, the support bracket 200 may have a distance adjustment screw hole for accommodating a distance adjustment screw Sc_a that adjusts a spacing between the first support wall 211 and the second support wall 213. For example, the distance adjustment screw hole may be provided between the two first upper support protrusions 233 of the first support wall 211 and between the two second upper support protrusions 223 of the second support wall 213.

In an exemplary embodiment, the support bracket 200 may have a fixing screw hole for accommodating a T-bar fixing screw Sc_b that passes through the first support wall 211, the T-bar Tb, and the second support wall 213 to fix the T-bar Tb to the support bracket 200. The fixing screw hole may be provided below the aforementioned distance adjustment screw hole.

In an exemplary embodiment, the support bracket 200 may have a support bar coupling screw hole for accommodating a support bar coupling screw Sc_c, the screw being provided in the connection wall 215 and coupling the connection wall 215 to an upper surface of the support bar Sb.

In an exemplary embodiment, the support bracket 200 may include protruding support walls 273, 274 protruding vertically from at least one of the first support wall 211 and the second support wall 213 and supporting at least a portion of the support bar Sb. For example, the protruding support walls 273, 274 may include a first protruding support wall 273 provided on the first support wall 211 defining the first hole Sb_H1 through which the support bar Sb passes, and a second protruding support wall 274 provided on the second support wall 213 defining the second hole Sb_H2 through which the support bar Sb passes. The protruding support walls 273, 274 may also have coupling screw holes 273H, 274H for screw coupling with the support bar. For example, the first protruding support wall 273 may have a screw hole through which a screw Sc_d fixing the first protruding support wall 273 and the support bar Sb passes.

As described above, exemplary embodiments have been disclosed with reference to the drawings and the specification. Although specific terms have been used to describe the embodiments, such terminology is intended only to explain the technical spirit of the present disclosure and is not intended to limit the scope of the present disclosure as defined by the claims. Accordingly, those skilled in the art will understand that various modifications and equivalent other embodiments can be made based on the present disclosure. Therefore, the true scope of legal protection of the present disclosure shall be defined by the technical spirit of the appended claims.

What is claimed is:

1. A mounting bracket configured to mount a sprinkler reducer on a support bar extending in a first direction, comprising:
a first base extending in a second direction perpendicular to the first direction and passing through the support bar;
a second base extending in the second direction and passing through the support bar, the second base being rotatable relative to the first base to enclose the sprinkler reducer together with the first base;
a fixing lever rotatable from the second base, coupled to the first base to enclose a front surface of the sprinkler reducer, and having fixing teeth at a portion thereof; and
an elastic hanger coupled to the second base and engaged with the fixing teeth when the first base and the second base are coupled by the fixing lever.

2. The mounting bracket according to claim 1,
wherein the first base comprises:
a first base wall having a first support hole through which the support bar passes; and
a plurality of first fixing walls bent from the first base wall and surrounding a portion of the sprinkler reducer, and
wherein the second base comprises:
a second base wall having a second support hole through which the support bar passes; and
a plurality of second fixing walls bent from the second base wall and arranged to at least partially overlap the plurality of first fixing walls and surrounding a portion of the sprinkler reducer.

3. The mounting bracket according to claim 2, further comprising:
a lever coupling shaft interposed between the plurality of first fixing walls; and
a lever fixing shaft interposed between the plurality of second fixing walls,
wherein the elastic hanger is disposed between the plurality of second fixing walls to be spaced apart from the lever fixing shaft, and
wherein the fixing lever comprises:
a handle rotatable from the lever fixing shaft and having fixing teeth engaged with the elastic hanger on one side; and
a locking wall rotatable from the handle and having a hook coupled to the lever coupling shaft.

4. The mounting bracket according to claim 3,
wherein, in a locked state in which the hook of the locking wall is coupled to the lever coupling shaft and the fixing teeth are engaged with the elastic hanger:
the first base and the second base are in contact with the sprinkler reducer, and
the locking wall is spaced apart from the sprinkler reducer.

5. The mounting bracket according to claim 2,
wherein the first base wall comprises:
a first upper flange supporting an upper surface of the support bar;
a first lower flange supporting a lower surface of the support bar; and
a first side flange supporting a rear surface of the support bar, and
wherein the second base wall comprises:
a second upper flange supporting the upper surface of the support bar;
a second lower flange supporting the lower surface of the support bar; and
a second side flange supporting the rear surface of the support bar.

6. The mounting bracket according to claim 1, further comprising a base rotation shaft provided at a rear portion of the support bar and passing through an overlapping portion of the first base and the second base.

7. The mounting bracket according to claim 6, further comprising a spring structure surrounding the base rotation shaft,
wherein one side of the spring structure is coupled to the first base, and the other side of the spring structure opposite to the one side of the spring structure is coupled to the second base.

8. The mounting bracket according to claim 7,
wherein the first base has a first spring coupling groove for accommodating the one side of the spring structure, and
wherein the second base has a second spring coupling groove for accommodating the other side of the spring structure.

9. The mounting bracket according to claim 1, further comprising a stopper protruding from an upper surface of the second base and configured to provide a restriction on rotation of the first base.

10. A support bracket disposed on a T-bar and configured to support a support bar coupled with a sprinkler reducer, comprising:
a support frame supporting one side of the support bar, the support frame comprising:
a first support wall passing through the support bar;
a second support wall facing the first support wall and passing through the support bar; and
a connection wall connecting the first support wall and the second support wall;
a first lower support protrusion protruding obliquely from an inner surface of the first support wall and increasing in protrusion length upward;
a second lower support protrusion protruding obliquely from an inner surface of the second support wall, increasing in protrusion length upward, and facing the first lower support protrusion;
a first upper support protrusion provided above the first lower support protrusion, protruding obliquely from the inner surface of the first support wall, and decreasing in protrusion length upward; and
a second upper support protrusion provided above the second lower support protrusion, protruding from the inner surface of the second support wall, and decreasing in protrusion length upward.

11. The support bracket according to claim 10, further comprising:
a first compression protrusion protruding from an inner surface of the first support wall and disposed between the first upper support protrusion and the first lower support protrusion; and
a second compression protrusion protruding from an inner surface of the second support wall and disposed between the second upper support protrusion and the second lower support protrusion.

12. The support bracket according to claim 10,
wherein the first support wall and the second support wall have a distance adjustment screw hole for accommodating a distance adjustment screw that adjusts a spacing between the first support wall and the second support wall.

13. The support bracket according to claim 10,
wherein the first support wall and the second support wall have a fixing screw hole for accommodating a T-bar fixing screw that passes through the first support wall, the T-bar, and the second support wall to fix the T-bar to the support bracket,
and wherein the fixing screw hole is provided above the first lower support protrusion and the second lower support protrusion, and below the first upper support protrusion and the second upper support protrusion.

14. The support bracket according to claim 10,
wherein, when the support bracket is viewed in plan, the first lower support protrusion and the second lower support protrusion are arranged symmetrically.

15. The support bracket according to claim 10,
wherein, when the support bracket is viewed in plan, the first upper support protrusion and the second upper support protrusion are arranged in a zigzag pattern, not facing each other.

16. The support bracket according to claim 10,
wherein a protrusion length of the first upper support protrusion and the second upper support protrusion is greater than a protrusion length of the first lower support protrusion and the second lower support protrusion.

17. The support bracket according to claim 10, further comprising a protruding support wall protruding perpendicularly from at least one of the first support wall and the second support wall and supporting a portion of the support bar.

18. The support bracket according to claim 10,
wherein the first support wall and the second support wall have a first hole for accommodating the support bar, and a second hole provided below the first hole at a different height for accommodating the support bar.

19. A sprinkler support assembly comprising:
a support bracket disposed on a T-bar and supporting a support bar extending in a first direction; and
a mounting bracket mounting a sprinkler reducer to the support bar,
wherein the support bracket comprises:
a support frame supporting one side of the support bar comprising:
a first support wall passing through the support bar;
a second support wall facing the first support wall and passing through the support bar; and
a connection wall connecting the first support wall and the second support wall;
a first lower support protrusion protruding obliquely from an inner surface of the first support wall and increasing in protrusion length upward;
a second lower support protrusion protruding obliquely from an inner surface of the second support wall, increasing in protrusion length upward, and facing the first lower support protrusion;
a first upper support protrusion provided above the first lower support protrusion, protruding obliquely from the inner surface of the first support wall, and decreasing in protrusion length upward; and
a second upper support protrusion provided above the second lower support protrusion, protruding from the inner surface of the second support wall, and decreasing in protrusion length upward,
wherein the mounting bracket comprises:
a first base extending in a second direction perpendicular to the first direction comprising:
a first base wall having a first support hole through which the support bar passes; and
a plurality of first fixing walls bent from the first base wall, surrounding a portion of the support bar, and having a first fixing groove enclosing a portion of the sprinkler reducer;
a second base disposed so as to at least partially overlap the first base and configured to rotate relative to the first base, comprising:
a second base wall having a second support hole through which the support bar passes; and
a plurality of second fixing walls bent from the second base wall, arranged to at least partially overlap the plurality of first fixing walls, surrounding a portion of the support bar, and having a second fixing groove enclosing a portion of the sprinkler reducer;
a lever coupling shaft interposed between the plurality of first fixing walls;
a lever fixing shaft interposed between the plurality of second fixing walls;
an elastic hanger interposed between the plurality of second fixing walls and spaced apart from the lever fixing shaft; and
a fixing lever coupled to the lever fixing shaft and configured to couple and decouple the first base and the second base comprising:
a handle rotatable from the lever fixing shaft and having fixing teeth engaged with the elastic hanger on one side; and
a locking member rotatable from the handle and having a hook coupled with the lever coupling shaft.
